(19) United States
(12) Patent Application Publication
(10) Pub. No.: US 2013/0211040 A1
(43) Pub. Date: Aug. 15, 2013

(54) POLYIMIDES AND POLYIMIDE FILMS

(71) Applicants: Hiroaki Nakao, Tokyo (JP); Youhei Inoue, Tokyo (JP); Masanori Kobayashi, Tokyo (JP)

(72) Inventors: Hiroaki Nakao, Tokyo (JP); Youhei Inoue, Tokyo (JP); Masanori Kobayashi, Tokyo (JP)

(73) Assignee: JFE CHEMICAL CORPORATION, Tokyo (JP)

(21) Appl. No.: 13/821,118

(22) PCT Filed: Sep. 5, 2011
(86) PCT No.: PCT/JP2011/070672

§ 371 Date: Apr. 15, 2013

(30) Foreign Application Priority Data
Sep. 7, 2010 (JP) 2010-199704
Jul. 7, 2011 (JP) 2011-150803

(51) Int. Cl. C08G 73/10

(52) U.S. Cl. CPC C08G 73/1053
USPC 528/338; 528/339

(57) ABSTRACT

A polyimide and a polyimide film obtained by reacting: an aromatic diamine, and 3,3′,4,4′-biphenyltetracarboxylic acid dianhydride, pyromellitic acid dianhydride, p-phenylenediamine and 4,4′-diaminodiphenyl ether, the amount of the component (I) being 0.1 to 10.0 mol % and the amount of the components (II) being 99.9 to 90.0 mol % based on the total amount of the component (I) and the components (II) (in Formula (1), R¹, R², R³ and R⁴ are each independently selected from the group consisting of a hydrogen atom, a halogen atom, a nitrogen-containing group, a linear or branched alkyl group with 1 to 12 carbon atoms, a linear or branched alkenyl group with 2 to 12 carbon atoms, a linear or branched alkoxy group with 1 to 12 carbon atoms, a hydroxyl group, a nitrile group, a nitro group, a carboxyl group, a carbamoyl group and an aromatic group with 6 to 12 carbon atoms).

### RELATED APPLICATIONS

This application is a §371 of International Application No. PCT/JP2011/070672, with an international filing date of Sep. 5, 2011 (WO 2012/033213 A1, published Mar. 15, 2012), which is based on Japanese Patent Application Nos. 2010-199704, filed Sep. 7, 2010, and 2011-150803, filed Jul. 7, 2011, the subject matter of which is incorporated herein by reference.

### TECHNICAL FIELD

This disclosure relates to polyimides and polyimide films. In particular, the disclosure relates to polyimides and polyimide films wherein the polyimides are synthesized from raw materials including an aromatic diamine having a fluorene-derived or a fluorene derivative-derived group, or an aromatic tetracarboxylic acid dianhydride.

### BACKGROUND

Polyimides exhibit not only high heat resistance, but also excellent properties including chemical resistance, radiation resistance, electric insulating properties and excellent mechanical characteristics. Thus, they have been currently used in a wide variation of electronic devices such as flexible printed wiring circuit boards, tape automation bonding boards, semiconductor element protective films and integrated circuit interlayer dielectric films.

Further, polyimides are very useful materials in terms of simple production, high film purity and easy property handling. Functional polyimide materials have been recently designed to fit individual various applications.

Many polyimides used in industry have a structure which makes them insoluble in organic solvents. Further, such polyimides do not melt even above their glass transition temperature. Thus, it is usually difficult to shape and process a polyimide itself. In general, a polyimide is synthesized by polymerizing an aromatic tetracarboxylic acid dianhydride such as pyromellitic acid anhydride and an aromatic diamine such as diaminodiphenyl ether in equimolar amounts in an aprotic polar organic solvent such as dimethylacetamide to form a polyamide acid (a polyamic acid) that is a polyimide precursor, and thereafter heating the polyamide acid at 250 to 350° C. to perform dehydration and cyclization (imidization) reactions.

However, it is often the case that a polyimide with a structure used in industry is dissolved in an organic solvent when it has a polyamide acid structure, but comes to be insoluble therein when it has formed a polyimide. Thus, a polyimide is commonly shaped and processed based on the use of a solution of a polyamide acid which is applied and dried to form a desired profile such as a film, a shaped article or a coating film and thereafter heated to complete imidization.

In the course in which a polyimide/copper substrate multilayer structure is cooled from the imidization temperature to room temperature, a thermal stress is generated which often causes severe problems such as curling, film separation and cracks. With greater density of recent electronic circuits being accompanied by adoption of multilayer wiring boards, the presence of residual stress in multilayer boards, even if such stress will not lead to the separation of a film or the occurrence of cracks, drastically lowers the reliability of the devices.

An effective remedy to lower thermal stress is to reduce the expansion of a polyimide. Most polyimides have a coefficient of linear thermal expansion of 30 to 100 ppm/° C. which is far greater than coefficients of linear thermal expansion of metal substrates, for example, that of copper being 17 ppm/° C.

Thus, studies have been carried out to develop a low thermal expansion polyimide having a coefficient close to that of copper, in detail not more than about 25 ppm/° C. In general, it has been reported that the main chain structure of a polyimide needs to be linear and rigid with inhibited internal rotation for the polyimide to exhibit low thermal expansion.

One of the best known practical low thermal expansion polyimides is a polyimide produced from 3,3′,4,4′-biphenyltetracarboxylic acid dianhydride and p-phenylenediamine. Polyimide films manufactured from this polyimide are known to exhibit a very low coefficient of linear thermal expansion of 5 to 10 ppm/° C. depending on the film thickness or production conditions.

However, as mentioned above, polyimides with a low thermal expansion coefficient have a rigid and linear main chain structure without exception. Thus, most of them are low in water vapor transmission and are liable to entrap gas bubbles depending on film production conditions.

In the case where the coefficient of linear thermal expansion is too low, curling occurs when such a polyimide film is laminated with an adhesive. In particular, because imidization by chemical ring-closing tends to result in in-plane orientation, the coefficient of linear thermal expansion will become excessively low with a rigid main chain structure.

Further, the densely packed molecules cause poor water vapor transmission of films. This is why gas bubbles are often entrapped inside the films during film production steps. This poor water vapor transmission also tends to cause problems such as swelling in a flexible copper clad laminate (FCCL) manufacturing step, in detail when lead bonding is performed.

Regarding the bond strength with copper after the FCCL manufacturing step, a film with heavy gas entrapment tends to exhibit poor adhesion because small amounts of gas are concentrated in the bonding surface. To improve this water vapor transmission, molecular packing is generally controlled by modifying molecules having a bent structure such as 4,4′-diaminodiphenyl ether. However, introducing a large amount of ether bonds results in decreases in heat resistance and tensile elastic modulus.

Japanese Unexamined Patent Application Publication No. 2006-183040 describes examples which achieved an improvement in water vapor transmission by mixing with other polyimide chains. However, such a mixing approach has a problem in terms of stable production of polyimide films.

It could therefore be helpful to provide polyimides and polyimide films having a coefficient of linear thermal expansion approximate to that of copper and exhibit high elastic modulus and good water vapor transmission without any deterioration in heat resistance.

### SUMMARY

We thus provide:
(1) A polyimide obtained by reacting:

Component (I): an aromatic diamine represented by Formula (1) below, and

Components (II): 3,3′,4,4′-biphenyltetracarboxylic acid dianhydride, pyromellitic acid dianhydride, p-phenylenediamine and 4,4′-diaminodiphenyl ether,

the amount of the component (I) being 0.1 to 10.0 mol % and the amount of the components (II) being 99.9 to 90.0 mol % based on the total amount of the component (I) and the components (II);

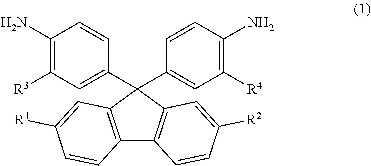

wherein in Formula (1), R¹, R², R³ and R⁴ are each independently selected from the group consisting of a hydrogen atom, a halogen atom, a nitrogen-containing group, a linear or branched alkyl group with 1 to 12 carbon atoms, a linear or branched alkenyl group with 2 to 12 carbon atoms, a linear or branched alkoxy group with 1 to 12 carbon atoms, a hydroxyl group, a nitrile group, a nitro group, a carboxyl group, a carbamoyl group and an aromatic group with 6 to 12 carbon atoms.
(2) A polyimide obtained by reacting:

Component (III): an aromatic tetracarboxylic acid dianhydride represented by Formula (2) below, and

Components (II): 3,3′,4,4′-biphenyltetracarboxylic acid dianhydride, pyromellitic acid dianhydride, p-phenylenediamine and 4,4′-diaminodiphenyl ether,

the amount of the component (III) being 0.1 to 2.5 mol % and the amount of the components (II) being 99.9 to 97.5 mol % based on the total amount of the component (III) and the components (II);

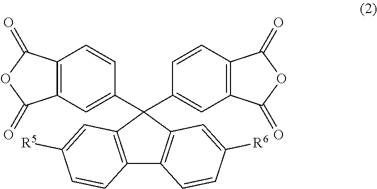

wherein in Formula (2), R⁵ and R⁶ are each independently selected from the group consisting of a hydrogen atom, a halogen atom, a nitrogen-containing group, a linear or branched alkyl group with 1 to 12 carbon atoms, a linear or branched alkenyl group with 2 to 12 carbon atoms, a linear or branched alkoxy group with 1 to 12 carbon atoms, a hydroxyl group, a nitrile group, a nitro group, a carboxyl group, a carbamoyl group and an aromatic group with 6 to 12 carbon atoms.
(3) A polyimide film that includes the polyimide described in (1).
(4) A polyimide film that includes the polyimide described in (2).
(5) The polyimide film described in (3) or (4), which has a water vapor transmission rate of 10 to 100 g/m²/day, an average coefficient of linear thermal expansion at 50 to 200° C. of 10 to 25 ppm/° C., no distinct glass transition temperature, and a tensile elastic modulus of not less than 5.0 GPa.

Polyimide films can thus be obtained which have a coefficient of linear thermal expansion approximate to that of copper and exhibit high elastic modulus and good water vapor transmission without any deterioration in heat resistance.

### DETAILED DESCRIPTION

We discovered that a polyimide produced by reacting a specific aromatic diamine or a specific aromatic tetracarboxylic acid dianhydride having a fluorene-derived or a fluorene derivative-derived group with 3,3′,4,4′-biphenyltetracarboxylic acid dianhydride, pyromellitic acid dianhydride, p-phenylenediamine and 4,4′-diaminodiphenyl ether in a specific molar ratio, and imidizing the thus-obtained polyimide precursor results in a polyimide film having a coefficient of linear thermal expansion approximate to that of copper and exhibits high elastic modulus and good water vapor transmission without any deterioration in heat resistance.

Hereinbelow, examples of our polyimides and polyimide films will be described in detail. It should be noted that these examples are only illustrative and this disclosure is not limited to such examples.

### Polyimides and Polyimide Films

We provide a polyimide obtained by reacting: Component (I): an aromatic diamine represented by Formula (1) below, and Components (II): 3,3′,4,4′-biphenyltetracarboxylic acid dianhydride, pyromellitic acid dianhydride, p-phenylenediamine and 4,4′-diaminodiphenyl ether, wherein the amount of the component (I) is 0.1 to 10.0 mol % and the amount of the components (II) is 99.9 to 90.0 mol % based on the total amount of the component (I) and the components (II) (hereinafter, sometimes referred to as “polyimide (1)”); a polyimide obtained by reacting: Component (III): an aromatic tetracarboxylic acid dianhydride represented by Formula (2) below, and Components (II): 3,3′,4,4′-biphenyltetracarboxylic acid dianhydride, pyromellitic acid dianhydride, p-phenylenediamine and 4,4′-diaminodiphenyl ether, wherein the amount of the component (III) is 0.1 to 2.5 mol % and the amount of the components (II) is 99.9 to 97.5 mol % based on the total amount of the component (III) and the components (II) (hereinafter, sometimes referred to as “polyimide (2)”); and a polyimide film including the polyimide (1) or the polyimide (2).

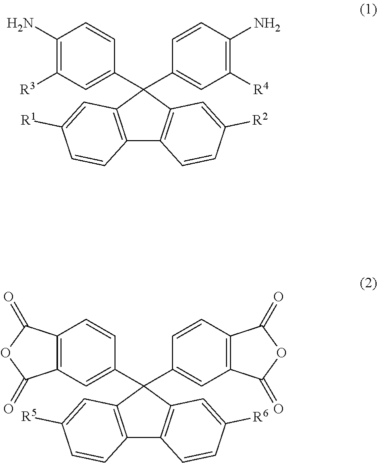

In Formulae (1) and (2), R¹, R², R³, R⁴, R⁵ and R⁶ are each independently selected from the group consisting of a hydrogen atom, a halogen atom, a nitrogen-containing group, a linear or branched alkyl group with 1 to 12 carbon atoms, a linear or branched alkenyl group with 2 to 12 carbon atoms, a linear or branched alkoxy group with 1 to 12 carbon atoms, a hydroxyl group, a nitrile group, a nitro group, a carboxyl group, a carbamoyl group and an aromatic group with 6 to 12 carbon atoms.

The nitrogen-containing group is not particularly limited as long as it is a monovalent group containing a nitrogen atom. It is preferable that the group have a free valence on the nitrogen atom. Specific examples include amino group (—NH₂), monomethylamino group (—NHCH₃) and dimethylamino group (—N(CH₃)₂). (The same applies hereinafter.)

The linear or branched alkyl group with 1 to 12 carbon atoms is not particularly limited as long as it is a group represented by General Formula CₙH₂ₙ₊₁— (n: natural number of 1 to 12). Specific examples include methyl group, ethyl group, 1-propyl group (n-propyl group) and 2-propyl group (isopropyl group). (The same applies hereinafter.)

The linear or branched alkenyl group with 2 to 12 carbon atoms is not particularly limited as long as it is a group represented by General Formula CₙH₂ₙ₋₁— (n: natural number of 2 to 12). The free valence may be on an unsaturated carbon atom or on a saturated carbon atom. Specific examples include vinyl group and allyl group. (The same applies hereinafter.)

The linear or branched alkoxy group with 1 to 12 carbon atoms is not particularly limited as long as it is a group represented by General Formula CₙH₂ₙ₊₁O— (n: natural number of 1 to 12). Specific examples include methoxy group and ethoxy group. (The same applies hereinafter.)

### Component (I)

The component (I) is an aromatic diamine represented by Formula (1). As described above, R¹, R², R³ and R⁴ are each independently selected from the group consisting of a hydrogen atom, a halogen atom, a nitrogen-containing group, a linear or branched alkyl group with 1 to 12 carbon atoms, a linear or branched alkenyl group with 2 to 12 carbon atoms, a linear or branched alkoxy group with 1 to 12 carbon atoms, a hydroxyl group, a nitrile group, a nitro group, a carboxyl group, a carbamoyl group and an aromatic group with 6 to 12 carbon atoms. It is preferable that R¹, R², R³ and R⁴ be hydrogen atoms, linear or branched alkyl groups with 1 to 12 carbon atoms, linear or branched alkenyl groups with 2 to 12 carbon atoms, or linear or branched alkoxy groups with 1 to 12 carbon atoms at the same time. It is more preferable that R¹, R², R³ and R⁴ be hydrogen atoms or methyl groups at the same time. It is still more preferable that R¹, R², R³ and R⁴ be hydrogen atoms at the same time.

### Components (II)

The components (II) are 3,3′,4,4′-biphenyltetracarboxylic acid dianhydride, pyromellitic acid dianhydride, p-phenylenediamine and 4,4′-diaminodiphenyl ether.

With respect to the components (II), the ratio of the number of moles (M_{BPTC}) of 3,3′,4,4′-biphenyltetracarboxylic acid dianhydride to the number of moles (M_{PMDA}) of pyromellitic acid dianhydride is not particularly limited, but M_{BPTC}:M_{PMDA} is preferably 1:1.1 to 1:0.5, more preferably 1:0.9 to 1:0.7, and still more preferably 1:0.8.

With respect to the components (II), the ratio of the number of moles (M_{PPDA}) of p-phenylenediamine to the number of moles (M_{DAPE}) of 4,4′-diaminodiphenyl ether is not particularly limited, but M_{PPDA}:M_{DAPE} is preferably 1:0.5 to 1:2, more preferably 1:0.7 to 1:1.4, still more preferably 1:0.9 to 1:1.1, and further preferably 1:1.

Regarding the tetracarboxylic acid dianhydrides among the components (II), part of 3,3′,4,4′-biphenyltetracarboxylic acid dianhydride or pyromellitic acid dianhydride may be replaced by one, or two or more kinds of the following tetracarboxylic acid dianhydrides.

Such tetracarboxylic acid dianhydrides include aliphatic tetracarboxylic acid dianhydrides such as ethylenetetracarboxylic acid dianhydride, butanetetracarboxylic acid dianhydride, cyclopentanetetracarboxylic acid dianhydride, cyclohexanetetracarboxylic acid dianhydride, 1,2,4,5-cyclohexanetetracarboxylic acid dianhydride and 1,2,3,4-cyclohexanetetracarboxylic acid dianhydride; and

aromatic tetracarboxylic acid dianhydrides such as 1,1-bis(2,3-dicarboxyphenyl)ethane dianhydride, bis(2,3-dicarboxyphenyl)methane dianhydride, bis(3,4-dicarboxyphenyl)methane dianhydride, 2,3′,3,4′-biphenyltetracarboxylic acid dianhydride, 2,2-bis(3,4-dicarboxyphenyl)propane dianhydride, 2,2-bis(2,3-dicarboxyphenyl)propane dianhydride, 2,2-bis(3,4-dicarboxyphenyl)-1,1,1,3,3,3-hexafluoropropane dianhydride, 2,2-bis(2,3-dicarboxyphenyl)-1,1,1,3,3,3-hexafluoropropane dianhydride, bis(3,4-dicarboxyphenyl)sulfone dianhydride, bis(3,4-dicarboxyphenyl)ether dianhydride, bis(2,3-dicarboxyphenyl)ether dianhydride, 3,3′,4,4′-benzophenonetetracarboxylic acid dianhydride, 2,2′,3,3′-benzophenonetetracarboxylic acid dianhydride, 3,3′,4,4′-oxydiphthalic acid dianhydride, 2,3,3′,4′-oxydiphthalic acid dianhydride, 1,2,5,6-naphthalenetetracarboxylic acid dianhydride, 1,4,5,8-naphthalenetetracarboxylic acid dianhydride, 2,3,6,7-naphthalenetetracarboxylic acid dianhydride, 1,2,3,4-benzene-tetracarboxylic acid dianhydride, 3,4,9,10-perylenetetracarboxylic acid dianhydride, 2,3,6,7-anthracenetetracarboxylic acid dianhydride and/or 1,2,7,8-phenanthrenetetracarboxylic acid dianhydride.

Regarding the diamines among the components (II), part of p-phenylenediamine or 4,4′-diaminodiphenyl ether may be replaced by one, or two or more kinds of the following diamines.

Such diamines include aliphatic diamines and aromatic diamines such as benzene aromatic diamino compounds, heteroaromatic diamino compounds and non-benzene aromatic diamino compounds.

Preferred examples of the aliphatic diamines include chain hydrocarbon compounds with 2 to 15 carbon atoms in which two hydrogen atoms are substituted with amino groups, with specific examples including pentamethylenediamine, hexamethylenediamine and heptamethylenediamine.

Preferred examples of the benzene aromatic diamino compounds include compounds having one benzene nucleus or 2 to 10 condensed or non-condensed benzene nuclei, with examples including the following compounds:
phenylenediamines such as m-phenylenediamine; phenylenediamine derivatives such as phenylenediamines substituted with an alkyl group such as methyl group or ethyl group, for example 2-methyl-1,4-diaminobenzene;
diaminodiphenyl compounds which have two aminophenyl groups bonded together at their phenyl groups via an ether bond, a sulfonyl bond, a thioether bond, a bond provided by an alkylene group of 1 to 6 carbon atoms or a derivative thereof (for example, an alkylene group in which one or more of the hydrogen atoms are substituted with atoms or groups such as halogen atoms), an imino bond, an azo bond, a phosphine oxide bond, an amide bond, a ureylene bond or any other bonding group, for example 3,3′-diaminodiphenyl ether, 3,4′-diaminodiphenyl ether, 4,4′-diaminodiphenyl ether, 3,3′-diaminodiphenyl sulfone, 3,4′-diaminodiphenyl sulfone, 4,4′-diaminodiphenyl sulfone, 3,3′-diaminodiphenyl methane, 3,4′-diaminodiphenyl methane, 4,4′-diaminodiphenyl methane, 4,4′-diaminodiphenyl sulfide, 3,3′-diaminodienyl ketone, 3,4′-diaminodiphenyl ketone, 2,2-bis(p-aminophenyl)propane, 2,2′-bis(p-aminophenyl)hexafluoropropane, 4-methyl-2,4-bis(p-aminophenyl)-1-pentene, 4-methyl-2,4-bis(p-aminophenyl)-2-pentene, iminodianiline, 4-methyl-2,4-bis(p-aminophenyl)pentane, bis(p-aminophenyl)phosphine oxide, 4,4′-diaminoazobenzene, 4,4′-diaminodiphenyl urea and 4,4′-diaminodiphenyl-amide;
diaminotriphenyl compounds which have two aminophenyl groups and one phenylene group bonded via other bonding groups (other than the bonding groups mentioned for the diaminodiphenyl compounds), for example, 1,3-bis(m-aminophenoxy)benzene, 1,3-bis(p-aminophenoxy)benzene and 1,4-bis(p-aminophenoxy)benzene;
diaminonaphthalenes such as 1,5-diaminonaphthalene and 2,6-diaminonaphthalene; aminophenyl aminoindanes such as 5- or 6-amino-1-(p-aminophenyl)-1,3,3-trimethylindane;
diaminotetraphenyl compounds such as 4,4′-bis(p-aminophenoxy)biphenyl, 2,2-bis(4-(4-aminophenoxy)phenyl)propane and 4,4′-bis(3-aminophenoxy)benzophenone; and
compounds corresponding to the aforementioned aromatic diamines except that a hydrogen atom is substituted with at least one substituent selected from the group consisting of a halogen atom, a methyl group, a methoxy group, a cyano group and a phenyl group.

### Component (III)

The component (III) is an aromatic tetracarboxylic acid dianhydride represented by Formula (2). As described above, R⁵ and R⁶ are each independently selected from the group consisting of a hydrogen atom, a halogen atom, a nitrogen-containing group, a linear or branched alkyl group with 1 to 12 carbon atoms, a linear or branched alkenyl group with 2 to 12 carbon atoms, a linear or branched alkoxy group with 1 to 12 carbon atoms, a hydroxyl group, a nitrile group, a nitro group, a carboxyl group, a carbamoyl group and an aromatic group with 6 to 12 carbon atoms. It is preferable that R⁵ and R⁶ be hydrogen atoms, linear or branched alkyl groups with 1 to 12 carbon atoms, linear or branched alkenyl groups with 2 to 12 carbon atoms, or linear or branched alkoxy groups with 1 to 12 carbon atoms at the same time. It is more preferable that R⁵ and R⁶ be hydrogen atoms or methyl groups at the same time. It is still more preferable that R⁵ and R⁶ be hydrogen atoms at the same time.

### Polyimide (1)

The amount of the component (I) is 0.1 to 10.0 mol % and the amount of the components (II) is 99.9 to 90.0 mol % based on the total amount of the component (I) and the components (II). These amounts ensure that the water vapor transmission rate becomes sufficient to meet a desired level as well as that film-forming properties are good. Based on the total amount of the component (I) and the components (II), the component (I) more preferably represents 2.0 to 8.0 mol %, and still more preferably 4.5 to 6.5 mol %. (Here, the mole percentage is rounded from two decimal places to one decimal place.)

It is preferable that (M_{FL}+M_{DA}):M_{TC} be 1:0.90 to 1:1.10, more preferably 1:0.95 to 1:1.05, and still more preferably 1:0.99 wherein (M_{FL}+M_{DA}) is the total of the number of moles (M_{FL}) of the aromatic diamine of the component (I) and the total number of moles (M_{DA}) of the diamines of the components (II), and (M_{TC}) is the total number of moles of the tetracarboxylic acid anhydrides of the components (II).

That is, the polymer units in Formula (3) have a ratio (a+b+c+d):(e+f) of 99.9 to 90.0 mol %:0.1 to 10.0 mol %. This ratio ensures that the water vapor transmission rate becomes sufficient to meet a desired level as well as that film-forming properties are good. The proportion of (e+f) is more preferably 2.0 to 8.0 mol %, and still more preferably 4.5 to 6.5 mol %. (Here, the mole percentage is rounded from two decimal places to one decimal place.)

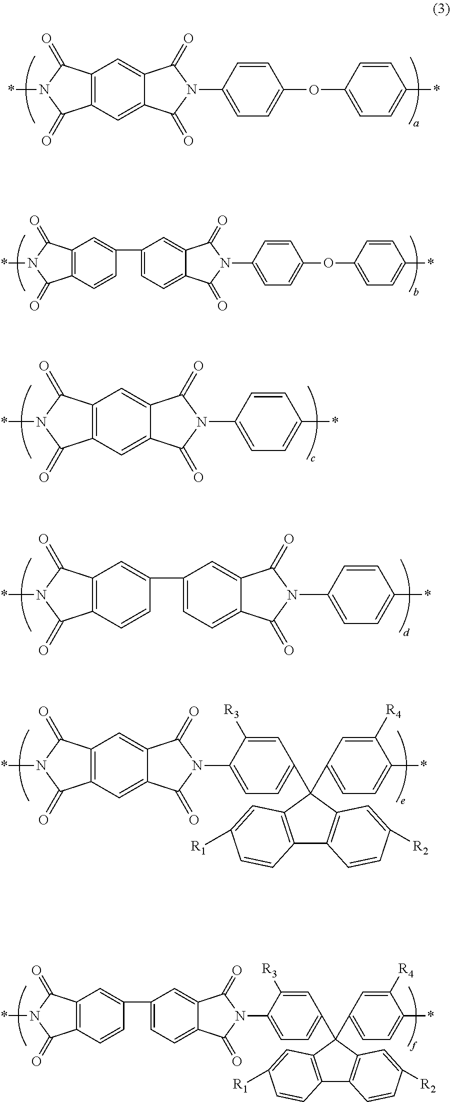

### Polyimide (2)

The amount of the component (III) is 0.1 to 2.5 mol % and the amount of the components (II) is 99.9 to 97.5 mol % based on the total amount of the component (III) and the components (II). These amounts ensure that the water vapor transmission rate becomes sufficient to meet a desired level as well as that film-forming properties are good. Based on the total amount of the component (III) and the components (II), the component (III) more preferably represents 1.0 to 2.5 mol %. (Here, the mole percentage is rounded from two decimal places to one decimal place.)

It is preferable that M_{DA}′:(M_{FL}′+M_{TC}′) be 1:0.90 to 1:1.10, more preferably 1:0.95 to 1:1.05, and still more preferably 1:0.99 wherein (M_{DA}′) is the total number of moles of the diamines of the components (II), and (M_{FL}′+M_{TC}′) is the total of the number of moles (M_{FL}′) of the aromatic tetracarboxylic acid anhydride of the component (I) and the total number of moles (M_{TC}′) of the tetracarboxylic acid anhydrides of the components (II).

That is, the polymer units in Formula (4) have a ratio (a+b+c+d):(g+h) of 99.9 to 97.5 mol %:0.1 to 2.5 mol %. This ratio ensures that the water vapor transmission rate becomes sufficient to meet a desired level as well as that film-forming properties are good. The proportion of (g+h) is more preferably 1.0 to 1.5 mol %. (Here, the mole percentage is rounded from two decimal places to one decimal place.)

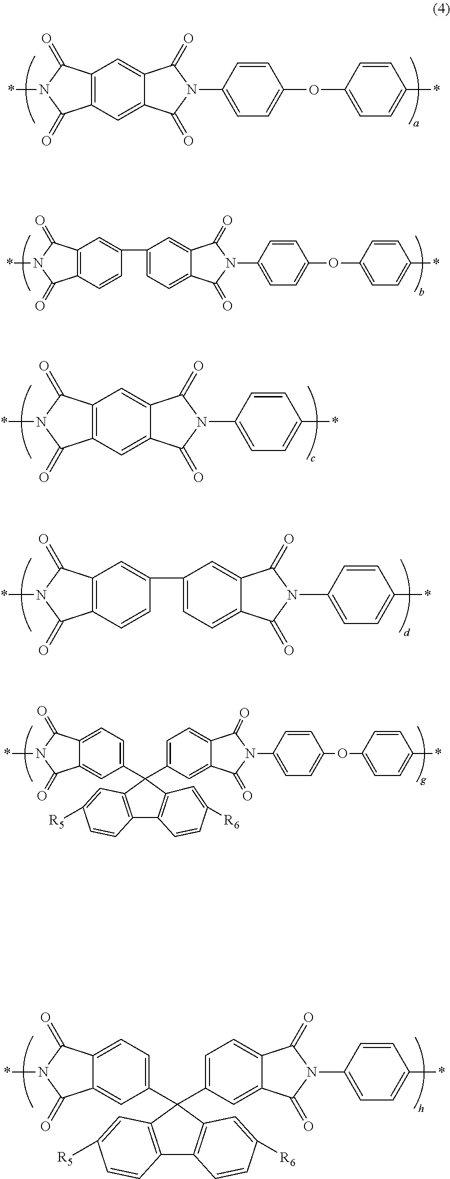

### Tensile Elastic Modulus

The tensile elastic modulus of our polyimide films is preferably not less than 5.0 GPa as measured by a measurement method in accordance with ASTM D882. Such a modulus ensures sufficient tensile strength. A higher tensile elastic modulus is more preferable. The tensile elastic modulus is more preferably not less than 5.8 GPa, still more preferably not less than 6.0 GPa, even more preferably not less than 6.3 GPa, and further preferably not less than 6.5 GPa.

### Coefficient of Linear Thermal Expansion

The coefficient of linear thermal expansion of our polyimide films is preferably 10 to 25 ppm/° C. in terms of an average of values determined at 50° C. to 200° C. based on the elongation of test pieces under a load of 0.5 g at a temperature increase rate of 5.0° C./min using TMA (Thermomechanical Analysis)-60 manufactured by Shimadzu Corporation. A coefficient of linear thermal expansion falling in this range is approximate to that of copper, 17 ppm/° C., and such a polyimide film enables a decrease in thermal stress when used in a polyimide/copper substrate multilayer structure.

### Glass Transition Temperature

The glass transition temperature of our polyimide films is determined based on the temperature at which the specific heat changes when the film is heated in a nitrogen atmosphere with a differential scanning calorimeter (DSC) at a temperature increase rate of 20° C./min. Preferably, our polyimide films do not have a distinct glass transition temperature.

### Water Vapor Transmission Rate

The water vapor transmission rate of our polyimide films is preferably 10 to 100 g/m²/day as determined by a measurement method in accordance with JIS K 7129: 2008 (Method A) in which the measurement temperature is 40° C., the measurement area is 50 cm², the relative humidity is 90% with 100% on the higher humidity side and 10% on the lower humidity side, and the measurement lower limit is 0.2 g/m²/day. This water vapor transmission rate is advantageous for stable manufacturing in view of the facts that it is sufficient to meet a desired level and makes the occurrence of gas entrapment unlikely.

The water vapor transmission rate is more preferably 25 to 100 g/m²/day or higher, even more preferably 40 to 100 g/m²/day or higher, and still more preferably 50 to 100 g/m²/day or higher.

### Methods for Producing Polyimides and Polyimide Films

To ensure a low coefficient of linear thermal expansion and a high elastic modulus, the polyimides are preferably produced by a chemical imidization method in which dehydration and cyclization (imidization) are performed using a catalyst to improve in-plane orientation. For example, a method may be used in which the tetracarboxylic acid dianhydride components and the diamine components are polymerized in an organic solvent at 5 to 40° C. for 3 to 10 hours, thereafter a dehydrating agent and a dehydration catalyst are admixed at a temperature of not more than 0° C., the resultant mixture is then applied over a glass plate to form a film, and the film is heat treated in an inert gas atmosphere or under a reduced pressure, usually at 200° C. to 400° C., preferably 250° C. to 350° C., for 0.5 to 15 hours, preferably 1 to 5 hours.

Examples of the solvents used herein include aprotic polar solvents such as N,N-dimethylformamide, N,N-dimethylacetamide and N-methyl-2-pyrrolidone; phenolic solvents such as cresols; and glycol solvents such as diglyme. These solvents may be used singly, or two or more may be used in combination. The amount of solvent is not particularly limited, but is desirably such that the content of the formed polyimide will be 5 to 40% by mass.

Examples of the dehydrating agents and the dehydration catalysts for chemical dehydration and ring-closing include a combination of acetic acid anhydride and picoline and a combination of trifluoroacetic acid anhydride and picoline.

### EXAMPLES

Our polyimides and polyimide films will be described in greater detail by EXAMPLES hereinbelow without limitation.

### Measurement Methods

The coefficient of linear thermal expansion, the mechanical toughness, the glass transition temperature and the water vapor transmission rate of polyimide films in EXAMPLES and COMPARATIVE EXAMPLES were measured by the following methods.

### (1) Tensile Elastic Modulus

The tensile elastic modulus was measured using autograph AGS-J500N manufactured by Shimadzu Corporation with respect to a 90 mm×10 mm rectangular test piece in accordance with ASTM D882 with a distance between chucks of 50 mm and a cross head speed of 50.8 mm/min at 23° C.

### (2) Coefficient of Linear Thermal Expansion

The coefficient of linear thermal expansion was determined in terms of an average of values measured at 50° C. to 200° C. based on the elongation of test pieces under a load of 0.5 g at a temperature increase rate of 5.0° C./min using TMA (Thermomechanical Analysis)-60 manufactured by Shimadzu Corporation.

### (3) Glass Transition Temperature

The glass transition temperature (Tg) was determined based on the temperature at which the specific heat changed when a test piece was heated in a nitrogen atmosphere with a differential scanning calorimeter (DSC) at a temperature increase rate of 20° C./min. “Undetected” means that the test piece did not show a distinct glass transition temperature.

### (4) Water Vapor Transmission Rate

The water vapor transmission rate was measured with an L80 series water vapor transmission rate meter manufactured by Lyssy in accordance with JIS K 7129: 2008 (Method A) under measurement conditions in which the measurement temperature was 40° C., the measurement area was 50 cm², the relative humidity was 90% with 100% on the higher humidity side and 10% on the lower humidity side, and the measurement lower limit was 0.2 g/m²/day.

### Example 1

A reaction vessel equipped with a stirrer, a reflux condenser and a nitrogen inlet tube was charged with 17.4 g (0.05 mol) of 9,9-bis(4-aminophenyl)fluorene (BAFL), 48.6 g (0.45 mol) of p-phenylenediamine and 100 g (0.50 mol) of 4,4′-diaminodiphenyl ether. These were completely dissolved by the addition of 1932 g of N,N-dimethylacetamide (DMAc).

Thereafter, 161.7 g (0.55 mol) of 3,3′,4,4′-biphenyltetracarboxylic acid dianhydride was added. Polymerization was carried out at room temperature. Further, 96.36 g (0.442 mol) of pyromellitic acid dianhydride (PMDA) was added. Thus, a polyimide precursor with a viscosity of about 1500 poise was prepared.

Acetic acid anhydride and β-picoline were added to this precursor. The mixture was applied over a flat and smooth glass plate and was dried by heating to accomplish imidization. Thus, a polyimide film with a film thickness of 30 βm was obtained.

The obtained polyimide film was tested by the aforementioned measurement methods to determine the tensile elastic modulus, the coefficient of linear thermal expansion, the glass transition temperature and the water vapor transmission rate. The results are described in the column of EXAMPLE 1 in Table 1.

### Example 2

A reaction vessel equipped with a stirrer, a reflux condenser and a nitrogen inlet tube was charged with 34.8 g (0.10 mol) of 9,9-bis(4-aminophenyl)fluorene (BAFL), 43.2 g (0.40 mol) of p-phenylenediamine and 100 g (0.50 mol) of 4,4′-diaminodiphenyl ether. These were completely dissolved by the addition of 1986 g of N,N-dimethylacetamide (DMAc).

Thereafter, 161.7 g (0.55 mol) of 3,3′,4,4′-biphenyltetracarboxylic acid dianhydride was added. Polymerization was carried out at room temperature. Further, 96.36 g (0.442 mol) of pyromellitic acid dianhydride (PMDA) was added. Thus, a polyimide precursor with a viscosity of about 1500 poise was prepared.

Acetic acid anhydride and β-picoline were added to this precursor. The mixture was applied over a flat and smooth glass plate and was dried by heating to accomplish imidization. Thus, a polyimide film with a film thickness of 30 μm was obtained.

The obtained polyimide film was tested by the aforementioned measurement methods to determine the tensile elastic modulus, the coefficient of linear thermal expansion, the glass transition temperature and the water vapor transmission rate. The results are described in the column of EXAMPLE 2 in Table 1.

### Example 3

A reaction vessel equipped with a stirrer, a reflux condenser and a nitrogen inlet tube was charged with 37.6 g (0.10 mol) of 9,9-bis(4-amino-3-methylphenyl)fluorene (BTFL), 43.2 g (0.40 mol) of p-phenylenediamine and 100 g (0.50 mol) of 4,4′-diaminodiphenyl ether. These were completely dissolved by the addition of 1988 g of N,N-dimethylacetamide (DMAc).

Thereafter, 161.7 g (0.55 mol) of 3,3′,4,4′-biphenyltetracarboxylic acid dianhydride was added. Polymerization was carried out at room temperature. Further, 96.36 g (0.442 mol) of pyromellitic acid dianhydride (PMDA) was added. Thus, a polyimide precursor with a viscosity of about 1500 poise was prepared.

Acetic acid anhydride and β-picoline were added to this precursor. The mixture was applied over a flat and smooth glass plate and was dried by heating to accomplish imidization. Thus, a polyimide film with a film thickness of 30 μm was obtained.

The obtained polyimide film was tested by the aforementioned measurement methods to determine the tensile elastic modulus, the coefficient of linear thermal expansion, the glass transition temperature and the water vapor transmission rate. The results are described in the column of EXAMPLE 3 in Table 1.

### Example 4

A reaction vessel equipped with a stirrer, a reflux condenser and a nitrogen inlet tube was charged with 54.0 g (0.50 mol) of p-phenylenediamine and 100 g (0.50 mol) of 4,4′-diaminodiphenyl ether. These were completely dissolved by the addition of 1983 g of N,N-dimethylacetamide (DMAc).

Thereafter, 23 g (0.05 mol) of 4,4′-(9-fluorenylidene)bisphthalic acid anhydride and 147.0 g (0.50 mol) of 3,3′,4,4′-biphenyltetracarboxylic acid dianhydride were added. Polymerization was carried out at room temperature. Further, 96.36 g (0.442 mol) of pyromellitic acid dianhydride (PMDA) was added. Thus, a polyimide precursor with a viscosity of about 1500 poise was prepared.

Acetic acid anhydride and β-picoline were added to this precursor. The mixture was applied over a flat and smooth glass plate and was dried by heating to accomplish imidization. Thus, a polyimide film with a film thickness of 30 μm was obtained.

The obtained polyimide film was tested by the aforementioned measurement methods to determine the tensile elastic modulus, the coefficient of linear thermal expansion, the glass transition temperature and the water vapor transmission rate. The results are described in the column of EXAMPLE 4 in Table 1.

### Example 5

A reaction vessel equipped with a stirrer, a reflux condenser and a nitrogen inlet tube was charged with 38.4 g (0.10 mol) of 9,9-bis(4-amino-3-fluorophenyl)fluorene (BFAF), 43.3 g (0.40 mol) of p-phenylenediamine and 100 g (0.50 mol) of 4,4′-diaminodiphenyl ether. These were completely dissolved by the addition of 1995 g of N,N-dimethylacetamide (DMAc).

Thereafter, 161.75 g (0.55 mol) of 3,3′,4,4′-biphenyltetracarboxylic acid dianhydride was added. Polymerization was carried out at room temperature. Further, 96.36 g (0.442 mol) of pyromellitic acid dianhydride (PMDA) was added. Thus, a polyimide precursor with a viscosity of about 1500 poise was prepared.

Acetic acid anhydride and β-picoline were added to this precursor. The mixture was applied over a flat and smooth glass plate and was dried by heating to accomplish imidization. Thus, a polyimide film with a film thickness of 30 μm was obtained.

The obtained polyimide film was tested by the aforementioned measurement methods to determine the tensile elastic modulus, the coefficient of linear thermal expansion, the glass transition temperature and the water vapor transmission rate. The results are described in the column of EXAMPLE 5 in Table 1.

### Example 6

A reaction vessel equipped with a stirrer, a reflux condenser and a nitrogen inlet tube was charged with 50.1 g (0.10 mol) of 9,9-bis(4-amino-3-phenylphenyl)fluorene (BPAF), 43.3 g (0.40 mol) of p-phenylenediamine and 100 g (0.50 mol) of 4,4′-diaminodiphenyl ether. These were completely dissolved by the addition of 2050 g of N,N-dimethylacetamide (DMAc).

Thereafter, 161.75 g (0.55 mol) of 3,3′,4,4′-biphenyltetracarboxylic acid dianhydride was added. Polymerization was carried out at room temperature. Further, 96.36 g (0.442 mol) of pyromellitic acid dianhydride (PMDA) was added. Thus, a polyimide precursor with a viscosity of about 1500 poise was prepared.

Acetic acid anhydride and β-picoline were added to this precursor. The mixture was applied over a flat and smooth glass plate and was dried by heating to accomplish imidization. Thus, a polyimide film with a film thickness of 30 μm was obtained.

The obtained polyimide film was tested by the aforementioned measurement methods to determine the tensile elastic modulus, the coefficient of linear thermal expansion, the glass transition temperature and the water vapor transmission rate. The results are described in the column of EXAMPLE 6 in Table 1.

### Example 7

A reaction vessel equipped with a stirrer, a reflux condenser and a nitrogen inlet tube was charged with 54.0 g (0.50 mol) of p-phenylenediamine and 100 g (0.50 mol) of 4,4′-diaminophenyl ether. These were completely dissolved by the addition of 1950 g of N,N-dimethylacetamide (DMAc).

Thereafter, 46 g (0.10 mol) of 4,4′-(9-fluorenylidene)bisphthalic acid anhydride and 132.1 g (0.45 mol) of 3,3′,4,4′-biphenyltetracarboxylic acid dianhydride were added. Polymerization was carried out at room temperature. Further, 96.36 g (0.442 mol) of pyromellitic acid dianhydride (PMDA) was added. Thus, a polyimide precursor with a viscosity of about 1500 poise was prepared.

Acetic acid anhydride and β-picoline were added to this precursor. The mixture was applied over a flat and smooth glass plate and was dried by heating to accomplish imidization. Thus, a polyimide film with a film thickness of 30 μm was obtained.

The obtained polyimide film was tested by the aforementioned measurement methods to determine the tensile elastic modulus, the coefficient of linear thermal expansion, the glass transition temperature and the water vapor transmission rate. The results are described in the column of EXAMPLE 7 in Table 1.

### Comparative Example 1

A reaction vessel equipped with a stirrer, a reflux condenser and a nitrogen inlet tube was charged with 54 g (0.50 mol) of p-phenylenediamine and 100 g (0.50 mol) of 4,4′-diaminodiphenyl ether. These were completely dissolved by the addition of 1877 g of N,N-dimethylacetamide (DMAc).

Thereafter, 161.7 g (0.55 mol) of 3,3′,4,4′-biphenyltetracarboxylic acid dianhydride was added. Polymerization was carried out at room temperature. Further, 96.36 g (0.442 mol) of pyromellitic acid dianhydride (PMDA) was added. Thus, a polyimide precursor with a viscosity of about 1500 poise was prepared.

Acetic acid anhydride and β-picoline were added to this precursor. The mixture was applied over a flat and smooth glass plate and was dried by heating to accomplish imidization. Thus, a polyimide film with a film thickness of 30 μm was obtained.

The obtained polyimide film was tested by the aforementioned measurement methods to determine the tensile elastic modulus, the coefficient of linear thermal expansion, the glass transition temperature and the water vapor transmission rate. The results are described in the column of COMPARATIVE EXAMPLE 1 in Table 1.

### Comparative Example 2

A reaction vessel equipped with a stirrer, a reflux condenser and a nitrogen inlet tube was charged with 108 g (1.0 mol) of p-phenylenediamine. It was completely dissolved by the addition of 1821 g of N,N-dimethylacetamide (DMAc).

Thereafter, 291.6 g (0.992 mol) of 3,3′,4,4′-biphenyltetracarboxylic acid dianhydride was added. Polymerization was carried out at room temperature. Thus, a polyimide precursor with a viscosity of about 1500 poise was prepared.

Acetic acid anhydride and β-picoline were added to this precursor. The mixture was applied over a flat and smooth glass plate and was dried by heating to accomplish imidization. Thus, a polyimide film with a film thickness of 30 μm was obtained.

The obtained polyimide film was tested by the aforementioned measurement methods to determine the tensile elastic modulus, the coefficient of linear thermal expansion, the glass transition temperature and the water vapor transmission rate. The results are described in the column of COMPARATIVE EXAMPLE 2 in Table 1.

TABLE 1

| | | Coefficient | | Water |
|---|---|---|---|---|
| | Tensile | of linear | Glass | vapor |
| | elastic | thermal | transition | transmission |
| | modulus | expansion | temperature | rate |
| | [GPa] | [ppm/° C.] | [° C.] | [g/m²/day] |
| EX. 1 | 6.5 | 19 | undetected | 24 |
| EX. 2 | 6.7 | 21 | undetected | 52 |
| EX. 3 | 6.3 | 23 | undetected | 55 |
| EX. 4 | 6.8 | 20 | undetected | 28 |
| EX. 5 | 5.7 | 23 | undetected | 53 |
| EX. 6 | 5.2 | 24 | undetected | 57 |
| EX. 7 | 5.8 | 24 | undetected | 58 |
| COMP. EX. 1 | 5.8 | 16 | undetected | 8 |
| COMP. EX. 2 | 9.5 | 12 | undetected | 2 |

### Explanation of EXAMPLE 1

EXAMPLE 1 involved the use of 0.05 mol of 9,9-bis(4-aminophenyl)fluorene as the component (I), and the use of 1.942 mol in total of p-phenylenediamine, 4,4′-diaminodiphenyl ether, 3,3′,4,4′-biphenyltetracarboxylic acid dianhydride and pyromellitic acid dianhydride as the components (II).

Based on the total of the component (I) and the components (II), the component (I) represented 2.5 mol % and the components (II) represented 97.5 mol %.

As evident from Table 1, good results were obtained in all of tensile elastic modulus, coefficient of linear thermal expansion, glass transition temperature and water vapor transmission rate.

### Explanation of EXAMPLE 2

EXAMPLE 2 involved the use of 0.10 mol of 9,9-bis(4-aminophenyl)fluorene as the component (I), and the use of 1.892 mol in total of p-phenylenediamine, 4,4′-diaminodiphenyl ether, 3,3′,4,4′-biphenyltetracarboxylic acid dianhydride and pyromellitic acid dianhydride as the components (II).

Based on the total of the component (I) and the components (II), the component (I) represented 5.0 mol % and the components (II) represented 95.0 mol %.

As evident from Table 1, good results were obtained in all of tensile elastic modulus, coefficient of linear thermal expansion, glass transition temperature and water vapor transmission rate.

### Explanation of EXAMPLE 3

EXAMPLE 3 involved the use of 0.10 mol of 9,9-bis(4-amino-3-phenylphenyl)fluorene as the component (I), and the use of 1.892 mol in total of p-phenylenediamine, 4,4′-diaminodiphenyl ether, 3,3′,4,4′-biphenyltetracarboxylic acid dianhydride and pyromellitic acid dianhydride as the components (II).

Based on the total of the component (I) and the components (II), the component (I) represented 5.0 mol % and the components (II) represented 95.0 mol %.

As evident from Table 1, good results were obtained in all of tensile elastic modulus, coefficient of linear thermal expansion, glass transition temperature and water vapor transmission rate.

### Explanation of EXAMPLE 4

EXAMPLE 4 involved the use of 0.05 mol of 4,4′-(9-fluorenylidene)bisphthalic acid anhydride as the component (III), and the use of 1.942 mol in total of p-phenylenediamine, 4,4′-diaminodiphenyl ether, 3,3′,4,4′-biphenyltetracarboxylic acid dianhydride and pyromellitic acid dianhydride as the components (II).

Based on the total of the component (III) and the components (II), the component (III) represented 2.5 mol % and the components (II) represented 97.5 mol %.

As evident from Table 1, good results were obtained in all of tensile elastic modulus, coefficient of linear thermal expansion, glass transition temperature and water vapor transmission rate.

### Explanation of EXAMPLE 5

EXAMPLE 5 involved the use of 0.10 mol of 9,9-bis(4-amino-3-fluorophenyl)fluorene (BFAF) as the component (I), and the use of 1.892 mol in total of p-phenylenediamine, 4,4′-diaminodiphenyl ether, 3,3′,4,4′-biphenyltetracarboxylic acid dianhydride and pyromellitic acid dianhydride as the components (II).

Based on the total of the component (I) and the components (II), the component (I) represented 5.0 mol % and the components (II) represented 95.0 mol %.

As evident from Table 1, good results were obtained in all of tensile elastic modulus, coefficient of linear thermal expansion, glass transition temperature and water vapor transmission rate.

### Explanation of EXAMPLE 6

EXAMPLE 6 involved the use of 0.10 mol of 9,9-bis(4-amino-3-phenylphenyl)fluorene (BPAF) as the component (I), and the use of 1.892 mol in total of p-phenylenediamine, 4,4′-diaminodiphenyl ether, 3,3′,4,4′-biphenyltetracarboxylic acid dianhydride and pyromellitic acid dianhydride as the components (II).

Based on the total of the component (I) and the components (II), the component (I) represented 5.0 mol % and the components (II) represented 95.0 mol %.

As evident from Table 1, good results were obtained in all of tensile elastic modulus, coefficient of linear thermal expansion, glass transition temperature and water vapor transmission rate.

### Explanation of EXAMPLE 7

EXAMPLE 7 involved the use of 0.10 mol of 4,4′-(9-fluorenylidene)bisphthalic acid anhydride as the component (III), and the use of 1.892 mol in total of p-phenylenediamine, 4,4′-diaminodiphenyl ether, 3,3′,4,4′-biphenyltetracarboxylic acid dianhydride and pyromellitic acid dianhydride as the components (II).

Based on the total of the component (III) and the components (II), the component (III) represented 5.0 mol % and the components (II) represented 95.0 mol %.

As evident from Table 1, good results were obtained in all of tensile elastic modulus, coefficient of linear thermal expansion, glass transition temperature and water vapor transmission rate.

### Explanation of COMPARATIVE EXAMPLE 1

In COMPARATIVE EXAMPLE 1, the polyimide was synthesized using the components corresponding to the components (II) alone without the use of component corresponding to the component (I) or the component (III).

The molar ratio of the diamines to the tetracarboxylic acid dianhydrides was 1.00:0.992.

Good results were obtained in tensile elastic modulus, coefficient of linear thermal expansion and glass transition temperature. However, the water vapor transmission rate was insufficient.

### Explanation of COMPARATIVE EXAMPLE 2

In COMPARATIVE EXAMPLE 2, the polyimide was synthesized using 1.0 mol of p-phenylenediamine as a diamine and 0.992 mol of 3,3′,4,4′-biphenyltetracarboxylic acid dianhydride as a tetracarboxylic acid dianhydride, without the use of any components corresponding to the component (I), the components (II) and the component (III).

The molar ratio of the diamine to the tetracarboxylic acid dianhydride was 1.00:0.992.

Good results were obtained in tensile elastic modulus, coefficient of linear thermal expansion and glass transition temperature. However, the water vapor transmission rate was insufficient.

### INDUSTRIAL APPLICABILITY

Polyimide films can be provided which have a coefficient of linear thermal expansion approximate to that of copper and exhibit high elastic modulus and good water vapor transmission without any deterioration in heat resistance.

1. A polyimide obtained by reacting:
Component (I): an aromatic diamine represented by Formula (1) below, and
Components (II): 3,3′,4,4′-biphenyltetracarboxylic acid dianhydride, pyromellitic acid dianhydride, p-phenylenediamine and 4,4′-diaminodiphenyl ether,
an amount of the component (I) being 0.1 to 10.0 mol % and an amount of the components (II) being 99.9 to 90.0 mol % based on the total amount of the components (I) and (II); 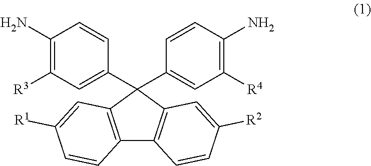
wherein in Formula (1), R¹, R², R³ and R⁴ are each independently selected from the group consisting of a hydrogen atom, a halogen atom, a nitrogen-containing group, a linear or branched alkyl group with 1 to 12 carbon atoms, a linear or branched alkenyl group with 2 to 12 carbon atoms, a linear or branched alkoxy group with 1 to 12 carbon atoms, a hydroxyl group, a nitrile group, a nitro group, a carboxyl group, a carbamoyl group and an aromatic group with 6 to 12 carbon atoms.

2. A polyimide obtained by reacting:
Component (III): an aromatic tetracarboxylic acid dianhydride represented by Formula (2) below, and
Components (II): 3,3′,4,4′-biphenyltetracarboxylic acid dianhydride, pyromellitic acid dianhydride, p-phenylenediamine and 4,4′-diaminodiphenyl ether,
an amount of the component (III) being 0.1 to 2.5 mol % and an amount of the components (II) being 99.9 to 97.5 mol % based on the total amount of the components (III) and (II); 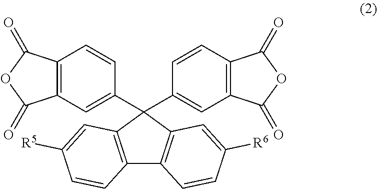
wherein in Formula (2), R⁵ and R⁶ are each independently selected from the group consisting of a hydrogen atom, a halogen atom, a nitrogen-containing group, a linear or branched alkyl group with 1 to 12 carbon atoms, a linear or branched alkenyl group with 2 to 12 carbon atoms, a linear or branched alkoxy group with 1 to 12 carbon atoms, a hydroxyl group, a nitrile group, a nitro group, a carboxyl group, a carbamoyl group and an aromatic group with 6 to 12 carbon atoms.

3. A polyimide film comprising the polyimide of claim 1.

4. A polyimide film comprising the polyimide of claim 2.

5. The polyimide film according to claim 3, having a water vapor transmission rate of 10 to 100 g/m²/day, an average coefficient of linear thermal expansion at 50 to 200° C. of 10 to 25 ppm/° C., no distinct glass transition temperature, and a tensile elastic modulus of not less than 5.0 GPa.

6. The polyimide film according to claim 4, having a water vapor transmission rate of 10 to 100 g/m²/day, an average coefficient of linear thermal expansion at 50 to 200° C. of 10 to 25 ppm/° C., no distinct glass transition temperature, and a tensile elastic modulus of not less than 5.0 GPa.
